(19) United States
(12) Patent Application Publication
(10) Pub. No.: US 2025/0076922 A1
(43) Pub. Date: Mar. 6, 2025

(54) SLIDABLE DISPLAY DEVICE

(71) Applicant: LG Display Co., Ltd., Seoul (KR)

(72) Inventors: Hyosung LEE, Gwangmyeong-si (KR); SeungHee LEE, Seoul (KR)

(73) Assignee: LG Display Co., Ltd., Seoul (KR)

(21) Appl. No.: 18/806,403

(22) Filed: Aug. 15, 2024

(30) Foreign Application Priority Data
Aug. 30, 2023 (KR) 10-2023-0114336

(51) Int. Cl. G06F 1/16

(52) U.S. Cl. CPC G06F 1/1624; G06F 1/1647; G06F 1/1656; G06F 1/1652

(57) ABSTRACT

A slidable display device in one example includes a display panel assembly including a display panel having a first display area and a second display area extending from the first display area, and a mounting frame. The display panel assembly can be movable in the mounting frame between a first position and a second position, the first position corresponding to a position in which the first display area extends beyond the mounting frame at a predetermined angle with respect to a portion of the second display area, and the second position corresponding to a position in which the first display area and the second display area extend at the predetermined angle beyond the mounting frame.

### CROSS-REFERENCE TO RELATED APPLICATIONS

This application claims priority to Korean Patent Application No. 10-2023-0114336 filed on Aug. 30, 2023, in the Korean Intellectual Property Office, the entire contents of which is hereby expressly incorporated by reference into the present application.

### BACKGROUND

### Field

The present disclosure relates to a display device, and more particularly, to a slidable display device capable of displaying images even though the slidable display device slides.

### Discussion of the Related Art

Display devices used as a monitor of a computer, a TV set, a mobile phone, and the like, may include an organic light-emitting display (OLED) configured to emit light by itself, and a liquid crystal display (LCD) that requires a separate light source.

The range of applications of such display devices is constantly being expanded from the use as a monitor of a computer, a TV set, and personal mobile devices to vehicles. Accordingly, research on developing display devices having wide display areas and reduced volumes is ongoing.

Further, a slidable display device is attracting attention as a next-generation display device. Such a slidable display device is manufactured by forming display parts, lines, or the like on a flexible substrate made of a flexible material, such as plastic, so that it can display images even when it is expanded or contracted in a sliding manner, has attracted attention as a next-generation display device. That is, the slidable display device can have a display area that is active while it is sliding between an exposed state and a retracted state.

### SUMMARY OF THE DISCLOSURE

An object to be achieved by the present disclosure is to provide a slidable display device mounted on a roof panel of a vehicle and configured to display images.

Another object to be achieved by the present disclosure is to provide a slidable display device capable of ensuring stability while the slidable display device slides.

Still another object to be achieved by the present disclosure is to provide a slidable display device capable of improving the durability of a display panel while the slidable display device slides.

Objects of the present disclosure are not limited to the above-mentioned objects, and other objects, which are not mentioned above, can be clearly understood by those skilled in the art from the following descriptions.

A slidable display device according to one aspect of the present disclosure may include a mounting frame, and a display panel assembly slidably disposed inside the mounting frame and including a display panel disposed to be movable to a lower side of the mounting frame, in which the display panel includes an always-on display area kept in a state of being disposed below the mounting frame, and an expanded display area configured to slide from the inside of the mounting frame and display images in a state in which the expanded display area is disposed below the mounting frame.

A slidable display device according to another aspect of the present disclosure may include a housing having a panel transfer path; a display panel capable of being transferred along the panel transfer path; a transfer assembly configured to transfer the display panel; and a guide roller assembly disposed on the panel transfer path and configured to guide the transfer of the display panel, in which the panel transfer path includes: a first path extending in a first direction; a second path extending in a second direction inclined with respect to the first direction; and a third path configured to connect the first path and the second path and configured to allow the display panel to be transferred between the first path and the second path while having a curvature.

A slidable display device according to yet another aspect of the present disclosure may include a display panel assembly including a display panel having a first display area and a second display area extending from the first display area; and a mounting frame, in which the display panel assembly is movable in the mounting frame between a first position and a second position, the first position corresponding to a position in which the first display area extends beyond the mounting frame at a predetermined angle with respect to a portion of the second display area, and the second position corresponding to a position in which the first display area and the second display area extend at the predetermined angle beyond the mounting frame.

A slidable display device according to still another aspect of the present disclosure may include a housing having a panel transfer path; a display panel being configured to move along the panel transfer path; a transfer assembly configured to move the display panel along the panel transfer path; and a guide roller assembly disposed on the panel transfer path, the guide roller assembly being configured to guide the display panel as the display moves along the panel transfer path, in which the panel transfer path includes: a first path extending in a first direction; a second path extending in a second direction inclined with respect to the first direction; and a third path connecting the first path and the second path, the third path being configured to bend the display panel while being moved between the first path and the second path.

A roof panel assembly for a vehicle according to an aspect of the present disclosure may include a roof panel having an opening; and a slidable display device connected to the roof panel assembly, the slidable display device including: a display panel assembly including a display panel having a first display area and a second display area extending from the first display area; and a mounting frame, in which the display panel assembly is movable in the mounting frame between a first position and a second position, the first position corresponding to a position in which the first display area extends through the opening of the roof panel at a predetermined angle with respect to a portion of the second display area, and the second position corresponding to a position in which the first display area and the second display area extend through the opening of the roof panel at the predetermined angle beyond the mounting frame.

Other detailed matters of the various embodiments are included in the detailed description and the drawings.

According to the present disclosure, the slidable display device is mounted on the roof panel of the vehicle and extended while sliding to allow the user to view the displayed images.

The present disclosure can ensure the stability of the display panel assembly during the sliding process.

The present disclosure may improve the durability of the display panel during the sliding process.

The effects according to the present disclosure are not limited to the contents exemplified above, and more various effects are included in the present specification.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic perspective view illustrating a state in which a slidable display device according to an embodiment of the present disclosure is mounted on a roof panel of a vehicle and displays images in an always-on display area of a display panel;

FIG. 2 is a schematic perspective view illustrating a state in which the slidable display device according to an embodiment of the present disclosure is mounted on the roof panel of the vehicle and displays images in the always-on display area and an expanded display area of the extended display panel;

FIG. 3A is a cross-sectional view of the slidable display device according to an embodiment of the present disclosure;

FIG. 3B is a perspective view of the slidable display device according to an embodiment of the present disclosure;

FIG. 4 is a partial cross-sectional view of the slidable display device according to an embodiment of the present disclosure;

FIG. 5 is a perspective view of a mounting frame and a guide member of the slidable display device according to an embodiment of the present disclosure;

FIG. 6 is a perspective view of a panel transfer part of the slidable display device according to an embodiment of the present disclosure;

FIG. 7 is an exploded perspective view of the panel transfer part of the slidable display device according to an embodiment of the present disclosure;

FIG. 8 is a perspective view of the panel transfer part of the slidable display device according to an embodiment of the present disclosure;

FIG. 9 is a schematic perspective view related to connection between the panel transfer part and a display panel assembly of the slidable display device according to an embodiment of the present disclosure;

FIG. 10 is an exploded perspective view of the display panel assembly of the slidable display device according to an embodiment of the present disclosure;

FIG. 11 is a perspective view of the slidable display device according to an embodiment of the present disclosure;

FIG. 12 is a perspective view illustrating a state in which a display panel is extended as the display panel assembly of the slidable display device according to an embodiment of the present disclosure slides;

FIG. 13 is a perspective view of a movement support part of the slidable display device according to an embodiment of the present disclosure;

FIG. 14 is a perspective view illustrating a state in which the movement support part of the slidable display device according to an embodiment of the present disclosure is extended downward as the display panel assembly slides; and

FIG. 15 is an exploded perspective view of the movement support part of the slidable display device according to an embodiment of the present disclosure.

### DETAILED DESCRIPTION OF THE EMBODIMENTS

Advantages and characteristics of the present disclosure and a method of achieving the advantages and characteristics will be clear by referring to various embodiments described below in detail together with the accompanying drawings. However, the present disclosure is not limited to the various embodiments disclosed herein but will be implemented in various forms. The various embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the various embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely coupled to or combined with each other and can be interlocked and operated in technically various ways, and the embodiments can be carried out independently of or in association with each other.

Hereinafter, various embodiments of the present disclosure will be described in detail with reference to the accompanying drawings. All the components of each display device according to all embodiments of the present disclosure are operatively coupled and configured.

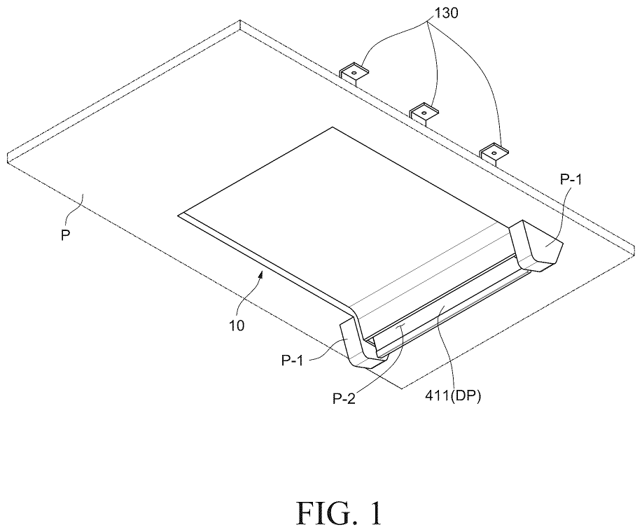

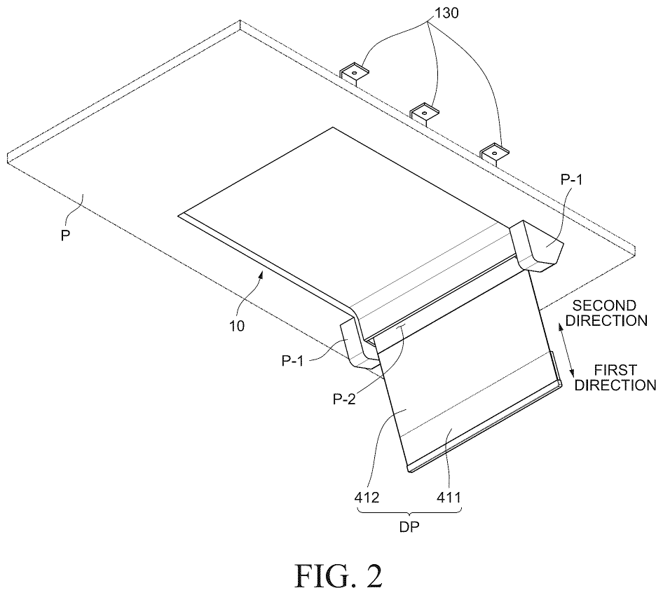

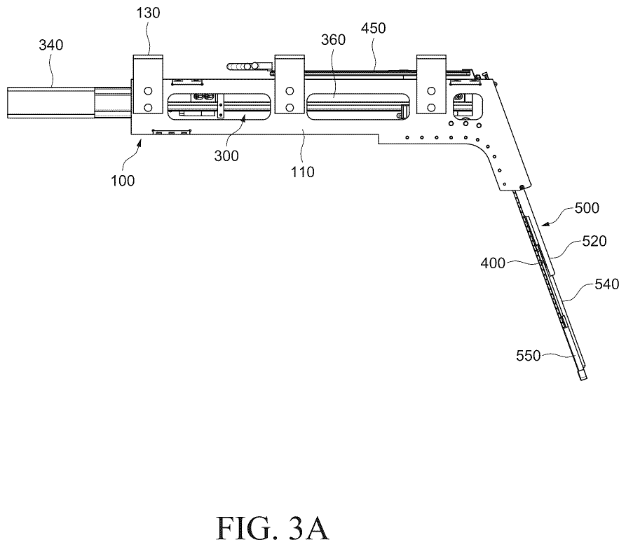

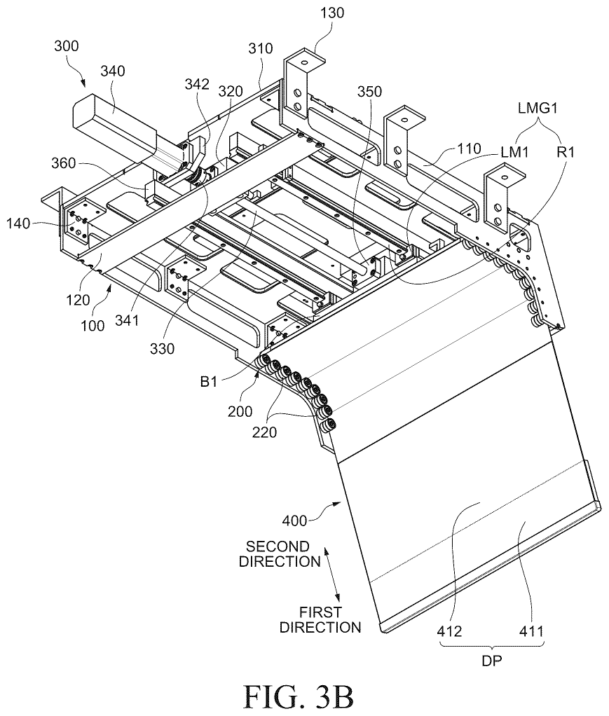

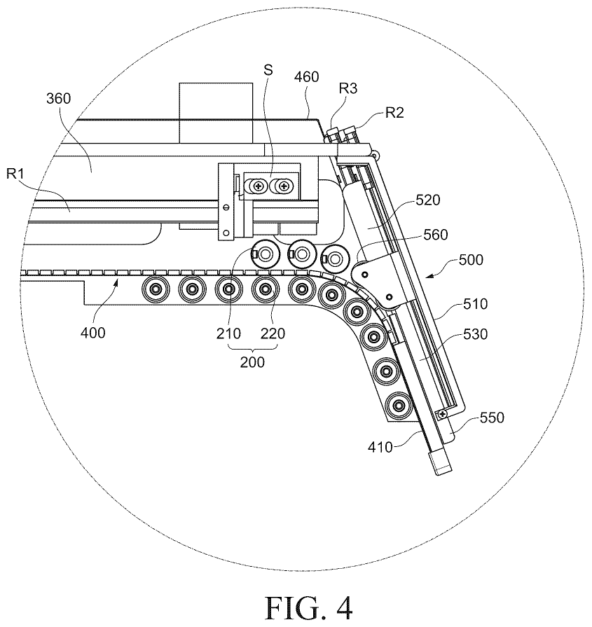

FIG. 1 is a schematic perspective view illustrating a state in which a slidable display device according to an embodiment of the present disclosure is disposed on a roof panel of a vehicle and displays images in an always-on display area of a display panel. FIG. 2 is a schematic perspective view illustrating a state in which the slidable display device according to an embodiment of the present disclosure is disposed on the roof panel of the vehicle and displays images in the always-on display area and an expanded display area of the expanded display panel. FIG. 3A is a cross-sectional view of the slidable display device according to an embodiment of the present disclosure. FIG. 3B is a perspective view of the slidable display device according to an embodiment of the present disclosure. FIG. 4 is a partial cross-sectional view of the slidable display device according to an embodiment of the present disclosure.

A structure of a slidable display device 10 according to an embodiment of the present disclosure will be described with reference to FIGS. 1 to 4.

The slidable display device 10 according to an embodiment of the present disclosure may be mounted in a space between an outer peripheral plate or body of the vehicle and a roof panel P of the vehicle disposed below the outer peripheral plate.

The roof panel P of the vehicle may include a pair of support ribs P-1 protruding downward and disposed to be spaced apart from each other. The roof panel P of the vehicle can include an opening P-2 formed in a space between the pair of support ribs P-1.

A display panel assembly 400 of the slidable display device 10 may slide and be extended into the vehicle through the opening P-2.

The slidable display device 10 may be applied to other objects having ceilings, in addition to the roof panel P of the vehicle.

The slidable display device 10 includes a mounting frame 100, a guide member 200, a panel transfer part 300, the display panel assembly 400, and a movement support part 500.

The mounting frame 100 may be disposed in a space between the outer peripheral plate of the vehicle and the roof panel P of the vehicle disposed below the outer peripheral plate. The guide member 200, the panel transfer part 300, and the movement support part 500 are mounted on the mounting frame 100.

The guide member 200 is mounted inside the mounting frame 100 and guides a sliding movement of the display panel assembly 400.

The panel transfer part 300 slides the display panel assembly 400 in a state in which a portion of the panel transfer part 300 is fixed inside the mounting frame 100. In other words, other portions of the panel transfer part 300 can move relative to the mounting frame 100 as described in greater detail below.

The movement support part 500 is mounted at one end of the mounting frame 100 and configured to support the sliding movement of the display panel assembly 400 while sliding together with the display panel assembly 400.

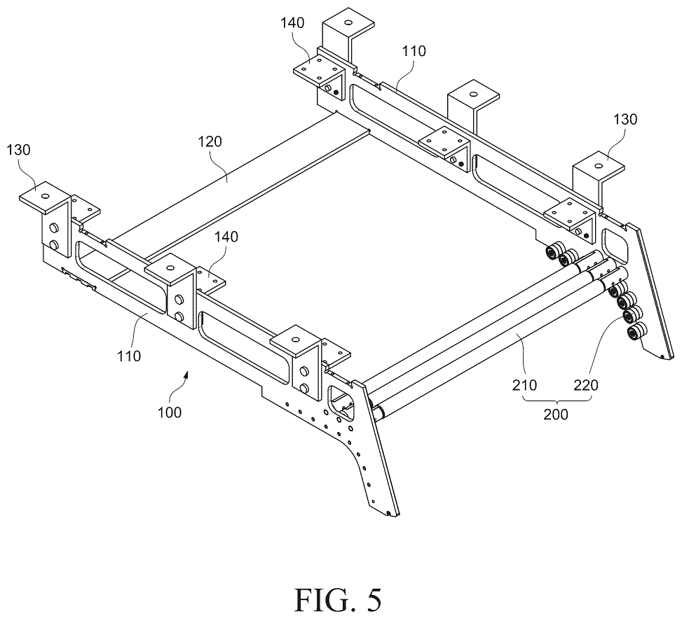

Hereinafter, the mounting frame 100 and the guide member 200 will be described in more detail with reference to FIG. 5 together.

FIG. 5 is a perspective view of the mounting frame and the guide member of the slidable display device according to an embodiment of the present disclosure.

The mounting frame 100 is fixed in the space between the outer peripheral plate of the vehicle and the roof panel P of the vehicle disposed below the outer peripheral plate. The mounting frame 100 defines a frame that constitutes an external shape of the slidable display device 10.

With reference to FIG. 5, the mounting frame 100 may include a pair of first support frames 110, a second support frame 120, mounting brackets 130, and fixing brackets 140.

The pair of first support frames 110 may be respectively disposed at two opposite sides of the mounting frame 100. That is, the pair of first support frames 110 may be respectively disposed at two opposite sides orthogonal to a sliding movement direction of the display panel assembly 400 in the mounting frame 100.

The second support frame 120 may be disposed at first ends of the pair of first support frames 110 and connect and support the pair of first support frames 110.

The plurality of mounting brackets 130 is fixed to outer surfaces of the pair of first support frames 110. The mounting brackets 130 may be fixed to an inner surface of the outer peripheral plate of the vehicle.

The plurality of fixing brackets 140 is fixed to inner surfaces of the pair of first support frames 110. A coupling plate 310 of the panel transfer part 300 may be fixed to and supported on the fixing brackets 140 (see FIG. 3B).

With reference to FIGS. 3B to 5, the guide member 200 is disposed at one end of the mounting frame 100 and guides the sliding movement of the display panel assembly 400.

The guide member 200 may include a plurality of upper rollers 210 and a plurality of lower rollers 220. The plurality of upper rollers 210 and the plurality of lower rollers 220 are each provided in the form of an idle roller (e.g., not directly driven to rotate) and may have a cylindrical or spherical shape. The plurality of upper rollers 210 and the plurality of lower rollers 220 are disposed to face one another in an upward/downward direction. Therefore, the display panel assembly 400 may stably slide while passing between the plurality of upper rollers 210 and the plurality of lower rollers 220.

The plurality of upper rollers 210 is rotatably coupled to the inner surfaces of the pair of first support frames 110.

The plurality of upper rollers 210 supports the sliding movement of the display panel assembly 400 while being rotated by friction with the display panel assembly 400 that slides in a first direction, in which the display panel assembly 400 is extended into the vehicle through the opening P-2 among the movement directions of the display panel assembly 400, or slides in a second direction opposite to the first direction, in which the display panel assembly is partially retracted through the opening P-2.

The plurality of upper rollers 210, which faces each other among the plurality of upper rollers 210, will be described. The plurality of upper rollers 210 is structured to be connected in a direction orthogonal to the sliding movement direction of the display panel assembly 400. Therefore, the plurality of upper rollers stably supports the sliding movement of the display panel assembly 400 while coming into contact with a surface of the display panel assembly 400 opposite to a surface on which a display panel 410 is provided.

The plurality of lower rollers 220 is rotatably coupled to the inner surfaces of the pair of first support frames 110. The plurality of lower rollers 220 is disposed below the plurality of upper rollers 210 and defines a sliding movement path of the display panel assembly 400 together with the plurality of upper rollers 210.

The pair of lower rollers 220, which faces each other among the plurality of lower rollers 220, will be described. That is, different from the plurality of upper rollers 210, the plurality of lower rollers can be provided as pairs of lower rollers 220 that are not connected to each other and supports two opposite portions of the display panel assembly 400 as it slides. Because each pair of lower rollers 220, which faces each other, are not connected to each other, the display panel 410 of the display panel assembly 400 slides without being covered at a lower side thereof.

The plurality of lower rollers 220 defines a first path extending in a first direction from one of the lower rollers 220 positioned at an end of the row of lower rollers, a second path extending in a second direction inclined with respect to the first direction at an angle of 90° to 130°, for example, 110°, and a third path configured to connect the first path and the second path to allow the display panel assembly 400 to move between the first path and the second path while having a particular curvature.

That is, the plurality of lower rollers 220 defines the first path extending in a direction parallel to the first support frame 110 from the lower roller 220 positioned at the end of the row of upper rollers, the second path extending to the end of the mounting frame 100 at an oblique angle to the first path, and the third path configured to connect the first path and the second path and arranged while having an arc shape between the first path and the second path.

In a situation that the second direction is inclined at an inclination angle of less than 90° in the transfer path of the display panel assembly 400, the display panel assembly 400 is extended while being bent excessively, which may make it inconvenient to view images displayed on the display panel 410 and increases stress applied to the display panel 410.

In a situation that the second direction is inclined at an inclination angle of more than 130° in the transfer path of the display panel assembly 400, the display panel assembly 400 is excessively extended while not protruding downward relative to the roof panel P, which may make it difficult to view images displayed on the display panel 410 and cause damage to the movement support part 500 coupled to the coupling plate 310 while the display panel assembly 400 slides.

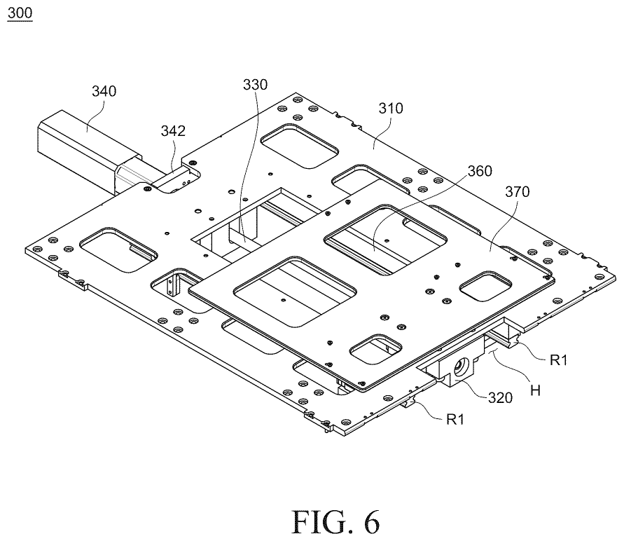

Hereinafter, the panel transfer part 300 and the display panel assembly 400 will be described in more detail with reference to FIGS. 6 to 12.

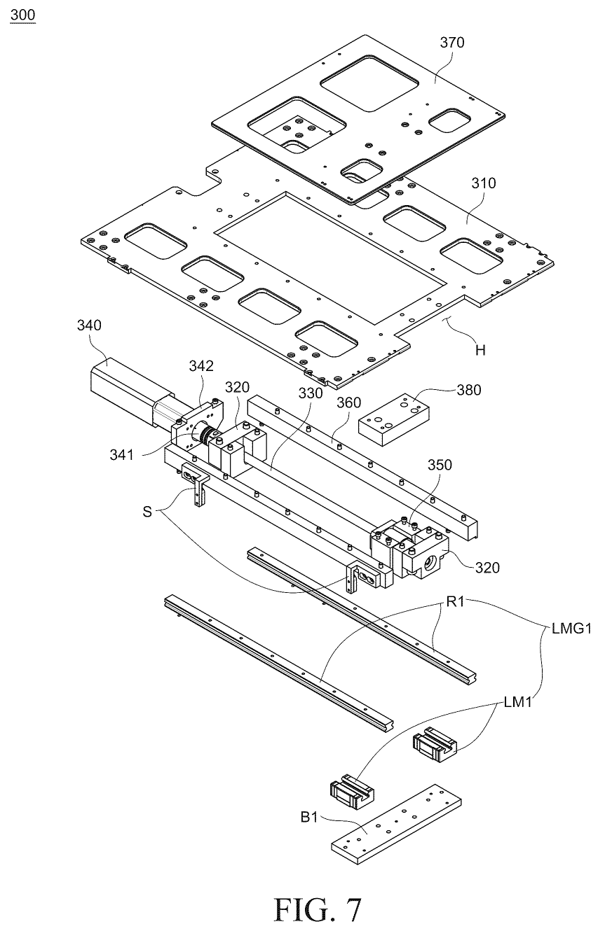

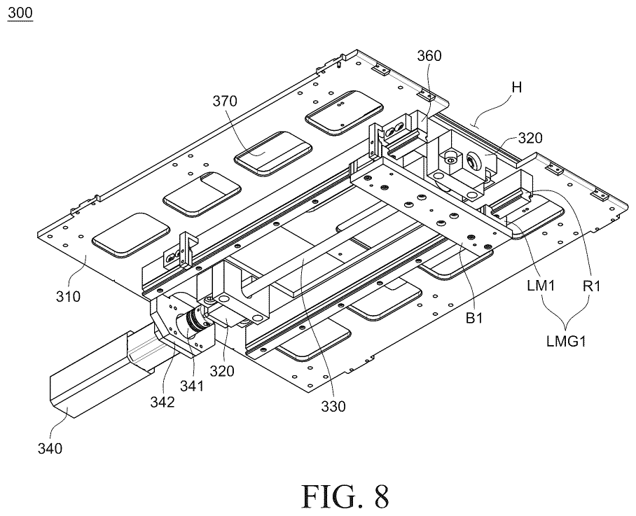

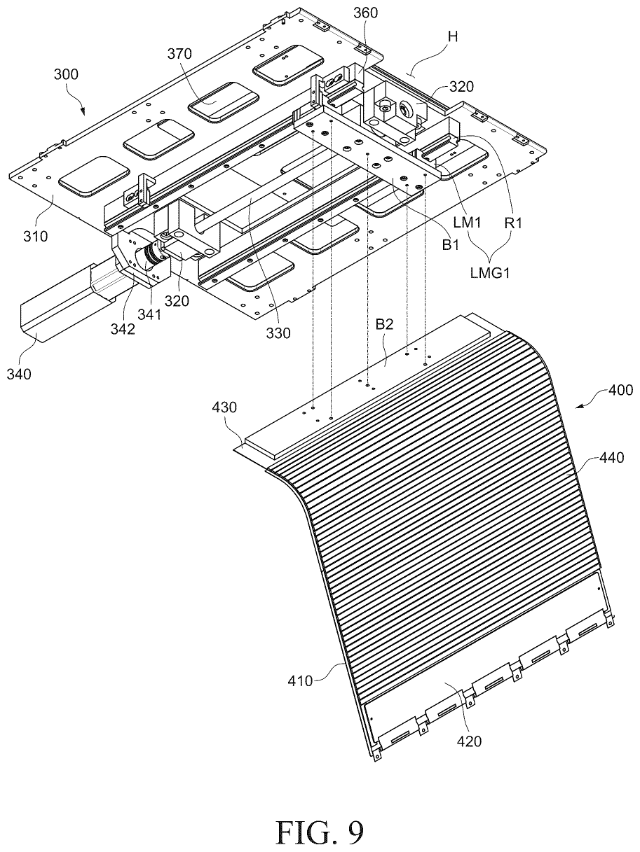

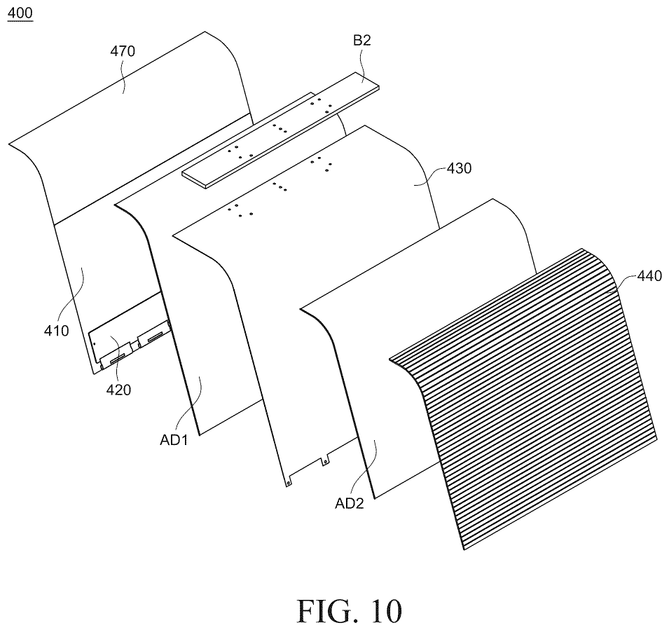

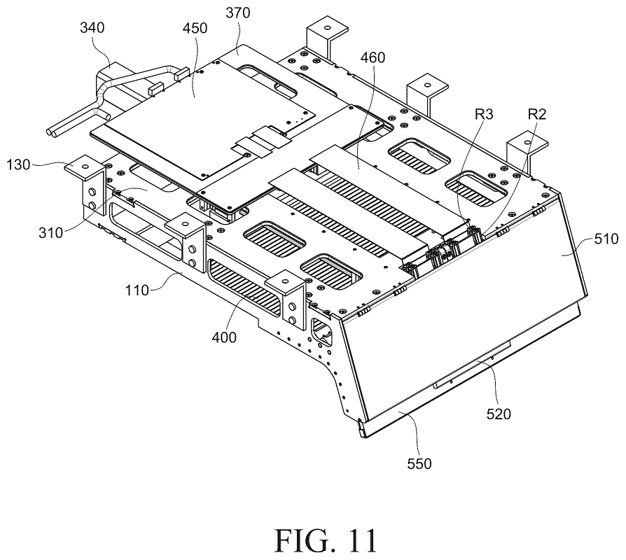

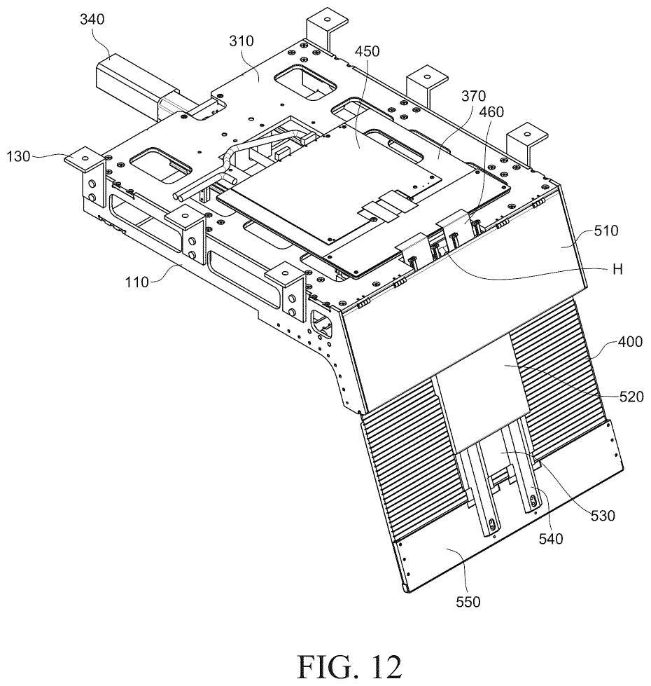

FIG. 6 is a perspective view of the panel transfer part of the slidable display device according to an embodiment of the present disclosure. FIG. 7 is an exploded perspective view of the panel transfer part of the slidable display device according to an embodiment of the present disclosure. FIG. 8 is a perspective view of the panel transfer part of the slidable display device according to an embodiment of the present disclosure. FIG. 9 is a schematic perspective view related to connection between the panel transfer part and the display panel assembly of the slidable display device according to an embodiment of the present disclosure. FIG. 10 is an exploded perspective view of the display panel assembly of the slidable display device according to an embodiment of the present disclosure. FIG. 11 is a perspective view of the slidable display device according to an embodiment of the present disclosure. FIG. 12 is a perspective view illustrating a state in which the display panel is expanded as the display panel assembly of the slidable display device according to an embodiment of the present disclosure slides.

The panel transfer part 300 is mounted on the mounting frame 100 and slides the display panel assembly 400. That is, the panel transfer part 300 can be coupled to the display panel assembly 400 to move the transfer part with respect to the mounting frame.

With reference to FIGS. 6 to 9, the panel transfer part 300 may include the coupling plate 310, a pair of support blocks 320, a rotary shaft 330, a drive motor 340, a carrier 350, a pair of supports 360, a pair of first guide rails R1, a pair of first linear motion (LM) blocks LM1, a first transfer bridge B1, a connection plate 370, and a connection bridge 380.

The coupling plate 310 is fixed to the plurality of fixing brackets 140 disposed on the mounting frame 100. The pair of support blocks 320, a motor support member 342, and the pair of supports 360 may be fixed to a lower surface of the coupling plate 310.

The coupling plate 310 includes a movement guide groove H formed at one end thereof. The movement guide groove H defines a path in which a flexible flat cable (FFC cable) 460 can move relative to a first support plate 510 of the movement support part 500 mounted on the coupling plate 310 (see FIGS. 11 and 12). That is, one side of the movement guide groove H is blocked by the first support plate 510 and thus has a hole shape, and the movement guide groove H defines the path through which the FFC cable 460, which is slid by a movement of the carrier 350, passes.

The pair of support blocks 320 is fixed to the lower surface of the coupling plate 310. The pair of support blocks 320 is disposed to be spaced apart from each other in the sliding movement direction of the display panel assembly 400.

Bearings are provided inside the pair of support blocks 320. A first end and a second end of the rotary shaft 330 are rotatably mounted in the bearings provided in the pair of support blocks 320, respectively. The pair of bearings fixes the rotary shaft 330 at predetermined positions that are not eccentric. That is, the pair of bearings may be colinear. The pair of bearings supports the weight of the rotary shaft 330 as it rotates. The pair of bearings supports a load applied to the rotary shaft 330.

The rotary shaft 330 may move the carrier 350 in the sliding movement direction of the display panel assembly 400 by means of driving power transmitted by the drive motor 340.

The rotary shaft 330 may have a ball screw shape. The rotary shaft 330 may convert a rotational motion of the drive motor 340 to a rectilinear reciprocating motion of the carrier 350 disposed on the rotary shaft 330. The rotary shaft 330 may be rotated by the drive motor 340 and rectilinearly move the carrier 350 to one side or the other side toward one side support block 320 or the other side support block 320. That is, the rotary shaft 330 can be rotated by the drive motor 340 and rectilinearly move the carrier 350 between one of the support blocks 320 at a first end of the rotary shaft 330 or the other support block 320 at a second end of the rotary shaft 320. Alternatively, other devices that convert rotary motion to linear motion, such as, a rack and pinion, could be used.

The drive motor 340 is connected to the other side support block 320 of the pair of support blocks 320 and transmits driving power to the rotary shaft 330.

The drive motor 340 is connected to the rotary shaft 330 through a coupler 341. Even though the rotary shaft 330 may deviate from concentricity during the process in which the carrier 350 moves, the coupler 341 holds the rotary shaft 330 so that the rotary shaft 330 rotates in a predetermined axial direction.

In the state in which the drive motor 340 is connected to the other side support block 320, the drive motor 340 may be supported by the motor support member 342 disposed between the drive motor 340 and the coupler 341. The motor support member 342 is fixed to a lower surface of the other end of the coupling plate 310.

The drive motor 340 may be connected to a power generation part, such as an external power source or an embedded battery, and supplied with power. The drive motor 340 generates a rotational force and transmits driving power to the rotary shaft 330 having a ball screw shape.

The drive motor 340 may rotate the rotary shaft 330 in response to positions of the first LM blocks LM1 received by the power generation part from a pair of position sensors S.

The carrier 350 may be disposed on the rotary shaft 330 and rectilinearly moved in the sliding movement direction of the display panel assembly 400 by the driving power transmitted by the drive motor 340. The carrier 350 may rectilinearly reciprocate in the first direction, in which the display panel assembly 400 is extended into the vehicle through the opening P-2, or the second direction, which is opposite to the first direction, among the movement directions of the display panel assembly 400.

The pair of supports 360 may be disposed at opposite sides of each of the support blocks 320. The pair of supports 360 may be fixed to the lower surface of the coupling plate 310 in the movement direction of the carrier 350.

The pair of position sensors S may be disposed on any one of the pair of supports 360 and spaced apart from each other. The pair of position sensors S may be respectively disposed on portions of the support 360 corresponding to the positions at which the pair of support blocks 320 is disposed.

The pair of position sensors S may detect the positions of the first LM blocks LM1 that move together with the carrier 350. A position signal related to the first LM blocks LM1 detected by the pair of position sensors S may be transmitted to the power generation part.

The pair of position sensors S may each be provided in the form of a limit sensor that detects the positions of the first LM blocks LM1 to restrict the movement of the carrier 350. The movement of the carrier 350 is restricted by the pair of position sensors S, which may suppress in advance damage to or breakage of the panel transfer part 300 or the occurrence of noise.

The power generation part may control (turn on or off) an operation of the drive motor 340 in response to the received position signal related to the first LM blocks LM1. The power generation part may perform control to allow the drive motor 340 to rotate the rotary shaft 330 in response to the received position signal related to the first LM blocks LM1. That is, the drive motor 340 can be turned off when one of the first LM blocks LM1 reaches a predetermined position next to one of the position sensors S.

The panel transfer part 300 may include a linear motion guide (LM guide) LMG1 to support the smooth sliding movement of the display panel assembly 400.

The LM guide LMG1 includes the pair of first guide rails R1 and the pair of first LM blocks LM1.

The pair of first guide rails R1 is respectively disposed on and fixed to lower surfaces of the pair of supports 360.

The pair of first LM blocks LM1 is movably disposed on the pair of first guide rails R1, respectively. The pair of first LM blocks LM1 is connected to the carrier 350 through the first transfer bridge B1 (see FIG. 8). Therefore, the pair of first LM blocks LM1 operates in conjunction with the movement of the carrier 350. That is, when the carrier 350 reciprocates in the first direction or the second direction, the pair of first LM blocks LM1, which is connected to the carrier 350 through the first transfer bridge B1, also reciprocates in the first direction or the second direction together with the carrier 350 along the pair of first guide rails R1.

The first transfer bridge B1 is connected to a lower surface of the carrier 350 and lower surfaces of the pair of first LM blocks LM1 and connects the carrier 350 and the pair of first LM blocks LM1.

The first transfer bridge B1 is also connected to a second transfer bridge B2 of the display panel assembly 400. Therefore, the pair of first LM blocks LM1 may be slid by the reciprocation of the carrier 350, and the display panel 410 of the display panel assembly 400 may also be slid by the reciprocation of the carrier 350.

The connection plate 370 may be coupled to the connection bridge 380 disposed on the carrier 350. An interface board 450 of the display panel assembly 400 may be mounted on the connection plate 370 and move with the movement of the carrier 350. Therefore, when the carrier 350 reciprocates in the first direction or the second direction, the pair of first LM blocks LM1 also reciprocates, and the second transfer bridge B2, which is connected to the first transfer bridge B1 coupled to the lower surface of the carrier 350 and the lower surfaces of the pair of first LM blocks LM1, also reciprocates. Alternatively, the interface board 450 could be mounted at a fixed position in the slidable display device 10; however, a larger FCC cable 460 would be necessary.

Because the second transfer bridge B2 is integrally connected to the first transfer bridge B1, the display panel 410 of the display panel assembly 400 slides in the first direction or the second direction while operating in conjunction with the carrier 350 and the pair of first LM blocks LM1.

Because the interface board 450 of the display panel assembly 400 is disposed on the connection plate 370 coupled to the connection bridge 380, the interface board 450 is slid in the first direction or the second direction together with the display panel 410 by the reciprocation of the carrier 350 simultaneously with the movement of the display panel 410.

That is, when the rotary shaft 330 is rotated by the operation of the drive motor 340, the carrier 350 rectilinearly reciprocates in the first direction or the second direction, and the interface board 450, which is disposed on the connection plate 370, and the display panel 410, which is integrally connected to the first transfer bridge B1 through the second transfer bridge B2, also slides in the first direction or the second direction simultaneously with the movement of the carrier 350 while operating in conjunction with the carrier 350.

As the display panel 410 and the interface board 450 slide simultaneously, the display panel assembly 400 slides in the first direction or the second direction, and the movement support part 500 is also slid in the first direction or the second direction by the sliding movement of the display panel assembly 400 while covering the display panel assembly 400.

The display panel assembly 400 may be slidably mounted on the mounting frame 100.

With reference to FIGS. 9 to 12, the display panel assembly 400 may include the display panel 410, a printed circuit board 420, a mid-cover 430, a plurality of back bars 440, the interface board 450, the FFC cable 460, the second transfer bridge B2, and a dummy panel 470.

The display panel 410 may slide downward through the opening P-2.

The display panel 410 may include a display element configured to display images, a driving element configured to operate the display element, and lines configured to transmit various types of signals to the display element and the driving element. The display panel 410 is disposed in parallel with the coupling plate 310 at ordinary times (e.g., when the display panel is in an extended state). When the display panel 410 is extended downward through the opening P-2, the display panel 410 moves inclinedly in a direction different from the direction of the coupling plate 310. The display panel 410 may have a flexible shape because the display panel 410 bends during a process in which the direction of the display panel 410 changes when the display panel 410 moves inclinedly. That is, because the display panel passes through a curved portion of the transfer path, the display panel 410 can conform to the shape of the curved portion of the transfer path.

With reference to FIG. 3B, the display panel 410 may have a display part DP. The display part DP may include an always-on display area 411 and an expanded display area 412.

The always-on display area 411 is an area of the display part DP provided in an always-on-display shape and kept in a state of being extended downward through the opening P-2. Therefore, the always-on display area 411 may be used as an area that may display a screen at ordinary times. The always-on display area 411 may display information, for example, date, weather, time, and the like. However, the present disclosure is not limited thereto. The always-on display area 411 may be in an off state, for example, a state without displaying a screen.

The printed circuit board 420 may be disposed on one side surface of the always-on display area 411 to operate the display part DP.

When the expanded display area 412 slides downward through the opening P-2, the mid-cover 430, the plurality of back bars 440, and the dummy panel 470 also slide through the opening P-2.

In the state in which the expanded display area 412 is moved, the expanded display area 412 and the always-on display area 411 may display images together or separately. That is, the display images can be a continuous image on the expanded display area 412 and the display area 411.

The printed circuit board 420 is electrically connected to an end of the display panel 410. The printed circuit board 420 is a component configured to supply a signal to a drive integrated circuit (IC). The printed circuit board 420 supplies the drive IC with various signals such as a driving signal or a data signal. A timing controller, a power source part, or the like may be disposed on the printed circuit board 420 and operate to display images in the always-on display area 411 and the expanded display area 412. The printed circuit board 420 may be provided in the form of a source printed circuit board (source PCB (S-PCB)) on which a data drive part is mounted.

The mid-cover 430 is disposed on one surface of the display panel 410 and supports the display panel 410 and the printed circuit board 420. The mid-cover 430 may have a larger area than the display panel 410 to protect the display panel 410 from an external impact.

The mid-cover 430 may include a material having flexibility so that the mid-cover 430 is not plastically deformed even though the display panel assembly 400 repeatedly slides. Specifically, the mid-cover 430 may include a material so that stress applied to the mid-cover 430 is equal to or lower than yield strength (yield stress) of the mid-cover 430 during the process in which the display panel 410 slides along the guide member 200. That is, the mid-cover 430 can elastically deform. The mid-cover 430 may include a material such as metal, rubber, plastic, or fabric. However, the material of the mid-cover 430 may be variously changed in accordance with design as long as the material of the mid-cover 430 satisfies physical property conditions such as a thermal deformation amount, a radius of curvature, or rigidity. However, the present disclosure is not limited thereto.

The mid-cover 430 may have a small thickness so that the mid-cover 430 is not plastically deformed even though the display panel assembly 400 repeatedly slides.

The mid-cover 430 includes a plurality of opening portions. The mid-cover 430 may include a pattern having a shape in which the plurality of opening portions having hole shapes is repeatedly disposed. For example, the plurality of opening portions may have various shapes such as an elliptical shape or a polygonal shape. However, the present disclosure is not limited thereto. Because the plurality of opening portions is flexibly deformed, the stress applied to the mid-cover 430 may be minimized even though the stress is applied to the display panel assembly 400 when the display panel assembly 400 repeatedly slides.

A first bonding layer AD1 is disposed between the mid-cover 430 and the display panel 410.

The first bonding layer AD1 may bond the mid-cover 430 and the display panel 410. The first bonding layer AD1 may be made of a material having bondability (e.g., adhesiveness). The first bonding layer AD1 may include a thermosetting or naturally curable bonding agent. The first bonding layer AD1 may include an optical clear adhesive (OCA) or a pressure sensitive adhesive (PSA). However, the present disclosure is not limited thereto.

The plurality of back bars 440 may be disposed on one surface of the mid-cover 430.

The plurality of back bars 440 supports the display panel 410 and the mid-cover 430. A thickness of the plurality of back bars 440 may be larger than a thickness of the mid-cover 430. The plurality of back bars 440 may protect the display panel 410 and the mid-cover 430 from an external impact.

The plurality of back bars 440 may include a material having rigidity. The plurality of back bars 440 may include a material such as a plastic material or a metallic material such as steel use stainless (SUS) or Invar. However, the material of the plurality of back bars 440 may be variously changed in accordance with design as long as the material of the plurality of back bars 440 satisfies physical property conditions such as a thermal deformation amount, a radius of curvature, or rigidity. However, the present disclosure is not limited thereto.

A second bonding layer AD2 is disposed between the plurality of back bars 440 and the mid-cover 430.

The second bonding layer AD2 may bond the mid-cover 430 and the plurality of back bars 440. The second bonding layer AD2 may be made of a material having bondability. The second bonding layer AD2 may include a material having elasticity. The second bonding layer AD2 may include a foam pad and elastic resin. However, the present disclosure is not limited thereto.

The interface board 450 is connected to the printed circuit board 420 to display images on the display part DP. The interface board 450 may be connected to an image controller so as to be supplied with power and control images displayed on the display part DP. The interface board 450 may be connected to the printed circuit board 420 through the FFC cable 460.

The interface board 450 is mounted on the connection plate 370 coupled to the connection bridge 380 coupled to the carrier 350. The interface board 450 slides when the connection plate 370 is moved in the first direction or the second direction by the movement of the carrier 350. When the carrier 350 moves, the interface board 450 slides in the first direction or the second direction simultaneously with the second transfer bridge B2 of the mid-cover 430 integrally coupled to the first transfer bridge B1. The interface board 450 is kept in the state in which the interface board 450 moves only at an upper side of the mounting frame 100. The interface board 450 slides in the first direction or the second direction at an upper side of the coupling plate 310.

The FFC cable 460 electrically connects the interface board 450 and the printed circuit board 420. The FFC cable 460 connects the interface board 450 and the printed circuit board 420 and allows the interface board 450 and the printed circuit board 420 to transmit or receive data, signals, or power for displaying images on the display part DP. The FFC cable 460 may include a material having flexibility. The FFC cable 460 is moved in the first direction or the second direction by both the movement of the display panel 410 by means of the first transfer bridge B1 and the movement of the connection plate 370 coupled to the connection bridge 380. When the FFC cable 460 moves in the first direction or the second direction, the FFC cable 460 moves downward (first direction) or upward (second direction) while passing through the movement guide groove H of the coupling plate 310, and the FFC cable 460 slides along a second support plate 520 and a third support plate 530 of the movement support part 500. That is, the FFC cable 460 may have a curved shape as it moves in the first direction or the second direction.

The second transfer bridge B2 is disposed at an upper end of the mid-cover 430. An upper surface of the second transfer bridge B2 is coupled to a lower surface of the first transfer bridge B1. The second transfer bridge B2 integrally coupled to the first transfer bridge B1 moves the mid-cover 430 in the first direction or the second direction simultaneously with the movement of the carrier 350 in the first direction or the second direction by the operation of the drive motor 340, such that the display panel 410 is extended downward through the opening P-2 or slid upward and accommodated in the mounting frame 100.

The dummy panel 470 may be disposed at an upper end of the display panel 410 opposite to a lower end of the display panel 410 at which the printed circuit board 420 is disposed. Because the dummy panel 470 is disposed at the upper end of the display panel 410, a particular length of the always-on display area 411 of the display panel 410 may be ensured so that the state in which the always-on display area 411 of the display panel 410 is extended downward through the opening P-2 at ordinary times is maintained so that the always-on display area 411 of the display panel 410 having a predetermined length is used in an always-on-display shape. That is, the presence of the dummy panel 470 allows for the area 411 of the display panel 410 to extend beyond the opening P-2 into the vehicle.

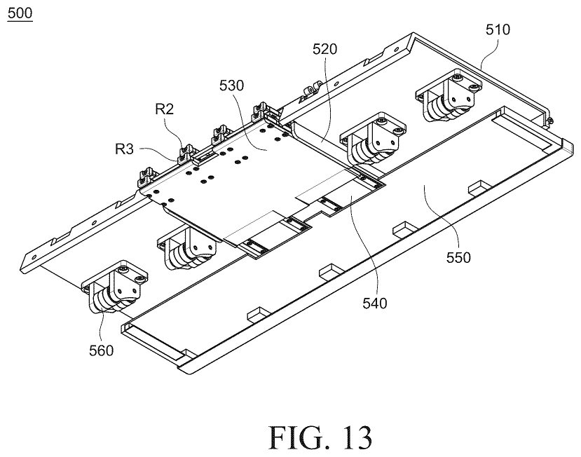

Hereinafter, the movement support part 500 will be described in detail with reference to FIGS. 13 to 15.

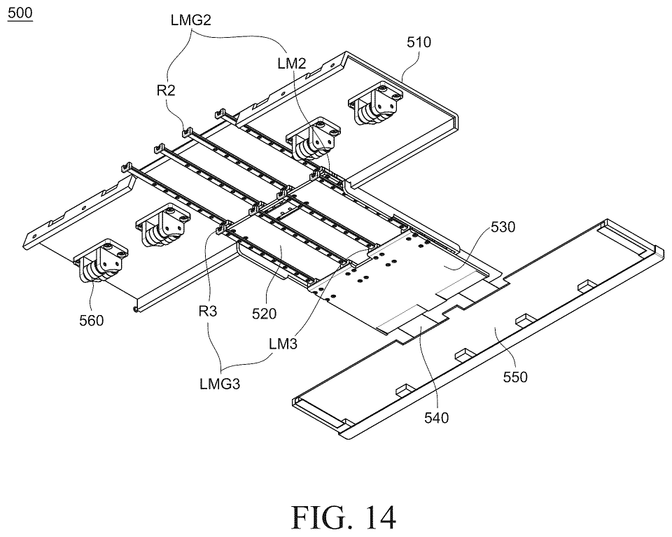

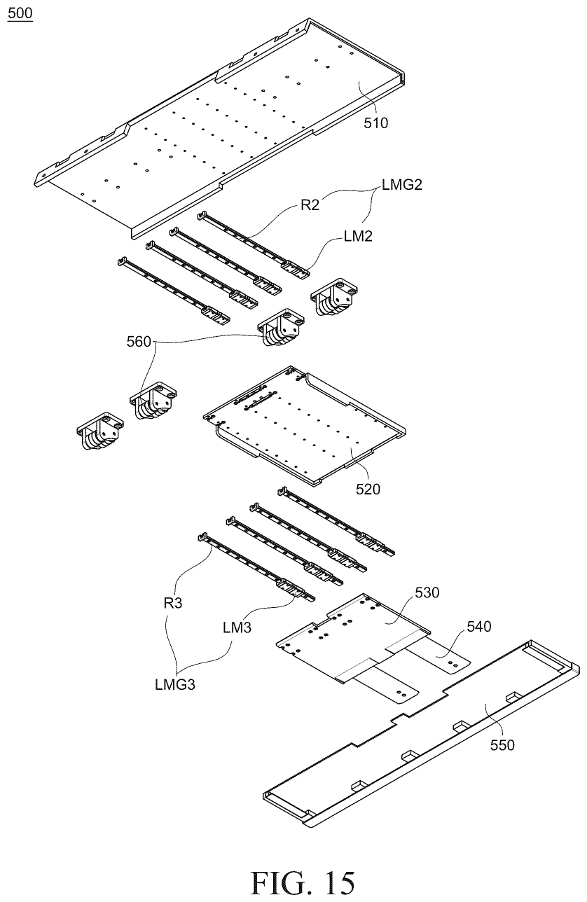

FIG. 13 is a perspective view of the movement support part of the slidable display device according to an embodiment of the present disclosure. FIG. 14 is a perspective view illustrating a state in which the movement support part of the slidable display device according to an embodiment of the present disclosure is expanded downward as the display panel assembly slides. FIG. 15 is an exploded perspective view of the movement support part of the slidable display device according to an embodiment of the present disclosure.

The movement support part 500 may be disposed at one end of the mounting frame 100. The movement support part 500 is connected to the display panel assembly 400 and covers and supports the display panel assembly 400 at one side thereof. The movement support part 500 may be extended downward by the sliding movement of the display panel assembly 400.

With reference to FIGS. 13 to 15, the movement support part 500 may include the first support plate 510, a plurality of second guide rails R2, a plurality of second LM blocks LM2, the second support plate 520, a plurality of third guide rails R3, a plurality of third LM blocks LM3, the third support plate 530, a connection bar 540, and a cover plate 550.

The first support plate 510 may be coupled to one end of the coupling plate 310 fixed to the fixing bracket 140 of the mounting frame 100. The first support plate 510 covers the display panel assembly 400 accommodated in the mounting frame 100 and supports loads of the plurality of second guide rails R2, the plurality of second LM blocks LM2, the second support plate 520, the plurality of third guide rails R3, the plurality of third LM blocks LM3, the third support plate 530, the connection bar 540, and the cover plate 550.

In the state in which the always-on display area 411 is kept disposed below the roof panel P of the vehicle, the plurality of second guide rails R2, the plurality of second LM blocks LM2, the second support plate 520, the plurality of third guide rails R3, the plurality of third LM blocks LM3, the third support plate 530, the connection bar 540, and the cover plate 550 may be disposed at the other side of the first support plate 510 while overlapping one another.

The movement support part 500 may include one or more LM guides to support the smooth sliding movements of the second support plate 520 and the third support plate 530 that obliquely slide upward or downward in accordance with the sliding movement of the display panel assembly 400. The LM guide has a shape including a guide rail and a LM block.

In the slidable display device 10 according to an embodiment of the present disclosure, second LM guides LMG2 and third LM guides LMG3 may be disposed on the movement support part 500.

The second LM guides LMG2 include the plurality of second guide rails R2 and the plurality of second LM blocks LM2. When the carrier 350 is moved in the first direction or the second direction by the operation of the drive motor 340, the second LM guides LMG2 slide the second support plate 520 downward (first direction) or upward (second direction).

The plurality of second guide rails R2 is disposed on the other side surface of the first support plate 510. That is, the plurality of second guide rails R2 are disposed on a lower side surface of the first support plate 510.

The plurality of second LM blocks LM2 may be respectively disposed on the plurality of second guide rails R2 and slide relative to the first support plate 510. When the carrier 350 is moved in the first direction or the second direction by the operation of the drive motor 340, the plurality of second LM blocks LM2 slides to move the second support plate 520 downward or upward.

The second support plate 520 is coupled to the other side surfaces of the plurality of second LM blocks LM2 and slid in the first direction or the second direction by the sliding movements of the plurality of second LM blocks LM2. That is, the second support plate 520 is coupled to lower surfaces of the plurality of LM blocks LM2.

The second support plate 520 moves together with the printed circuit board 420 and the cover plate 550 in the state in which the printed circuit board 420 and the cover plate 550 are coupled to the second support plate 520. That is, the second support plate 520 may move together with the display panel assembly 400 in accordance with the sliding movement of the display panel assembly 400 when the display panel 410 and the interface board 450 are moved in the first direction or the second direction by the sliding movement of the carrier 350.

The second support plate 520 covers one side of the FFC cable 460 that moves together with the movement of the interface board 450 in the first direction or the second direction. The second support plate 520 defines the movement path of the FFC cable 460. The second support plate 520 restricts the movement path of the FFC cable 460 to the inside of guide ribs formed at opposite sides of the FFC cable 460. The FFC cable 460 is moved in the first direction or the second direction by the movement of the display panel 410 by means of the first transfer bridge B1 and the movement of the connection plate 370 coupled to the connection bridge 380. When the FFC cable 460 moves in the first direction or the second direction, the FFC cable 460 moves downward or upward while passing in a curved shape through the movement guide groove H of the coupling plate 310, and the FFC cable 460 slides in the first direction or the second direction along the second support plate 520.

The third LM guides LMG3 include the plurality of third guide rails R3 and the plurality of third LM blocks LM3. When the carrier 350 is moved in the first direction or the second direction by the operation of the drive motor 340, the third LM guides LMG3 slide the third support plate 530 downward (first direction) or upward (second direction).

The plurality of third guide rails R3 is disposed on the other side surface of the second support plate 520. That is, the plurality of third guide rails R3 are disposed on a lower side surface of the second support plate 520.

The plurality of third LM blocks LM3 may be respectively disposed on the plurality of third guide rails R3 and slide. When the carrier 350 is moved in the first direction or the second direction by the operation of the drive motor 340, the plurality of third LM blocks LM3 slides to move the third support plate 530 downward or upward.

The third support plate 530 is coupled to the other side surfaces (e.g., lower side surfaces) of the plurality of third LM blocks LM3 and slid in the first direction or the second direction by the sliding movements of the plurality of third LM blocks LM3.

The third support plate 530 moves together with the printed circuit board 420 and the cover plate 550 in the state in which the printed circuit board 420 and the cover plate 550 are coupled to the third support plate 530. That is, the third support plate 530 may move together with the display panel assembly 400 in accordance with the sliding movement of the display panel assembly 400 when the display panel 410 and the interface board 450 are moved in the first direction or the second direction by the sliding movement of the carrier 350.

The third support plate 530 covers one side of the FFC cable 460 that moves together with the movement of the interface board 450 in the first direction or the second direction. The third support plate 530 defines the movement path of the FFC cable 460. The FFC cable 460 is moved in the first direction or the second direction by the movement of the display panel 410 by means of the first transfer bridge B1 and the movement of the connection plate 370 coupled to the connection bridge 380. When the FFC cable 460 moves in the first direction or the second direction, the FFC cable 460 moves downward or upward while passing in a curved shape through the movement guide groove H of the coupling plate 310, and the FFC cable 460 slides in the first direction or the second direction along the third support plate 530 via the second support plate 520.

The cover plate 550 is coupled to one or more connection bars 540 disposed on the third support plate 530 and covers the printed circuit board 420. The cover plate 550 may be disposed on the printed circuit board 420. Specifically, the cover plate 550 may be mounted at the end of the mid-cover 430 disposed on the printed circuit board 420 to cover the printed circuit board 420.

The movement support part 500 of the slidable display device 10 according to an embodiment of the present disclosure may further include a plurality of support rollers 560.

The plurality of support rollers 560 may be disposed on the other side surface (e.g., lower side surface) of the first support plate 510 and disposed at opposite sides of the second guide rails R2. That is, the plurality of support rollers 560 is disposed with the second guide rails R2 interposed therebetween and supports the display panel assembly 400 that slides in the first direction or the second direction. Therefore, the FFC cable 460 moves in the first direction or the second direction along spaces between the plurality of support rollers 560 while passing in a curved shape through the hole-shaped movement path defined by the movement guide groove H and the first support plate 510, such that damage to the FFC cable 460 during the movement process may be suppressed.

The plurality of support rollers 560 may be disposed in a shape extending from the plurality of upper rollers 210 to one side in the state in which the first support plate 510 is disposed at one end of the coupling plate 310. That is, the plurality of support rollers 560 can be disposed at one end of the plurality of upper rollers. Therefore, during the sliding movement, when the display panel assembly 400 moves between the plurality of upper rollers 210 and the plurality of lower rollers 220 and enters the curved surface defined by the arrangement of the plurality of lower rollers 220, the display panel assembly 400 may be supported while moving between the plurality of support rollers 560 and the plurality of lower rollers 220, such that the display panel assembly 400 may stably slide.

Hereinafter, the sliding movement process of the display panel assembly 400 in the state in which the slidable display device 10 according to an embodiment of the present disclosure is disposed on the roof panel P of the vehicle will be described.

When electric power is supplied from the power generation part, the drive motor 340 transmits driving power to rotate the rotary shaft 330 in the state in which the always-on display area 411 is disposed below the roof panel P of the vehicle through the opening P-2.

When the rotary shaft 330, which is connected to a rotary shaft of the drive motor 340 through the coupler 341, rotates, the carrier 350 is moved in the first direction. In this situation, the carrier 350 is moved while being supported by the first LM blocks LM1.

When the carrier 350 rectilinearly moves in the first direction, the second transfer bridge B2 integrally connected to the first transfer bridge B1 coupled to the carrier 350 also slides, such that the display panel 410 slides. At the same time, the connection plate 370 mounted on the connection bridge 380 coupled to the carrier 350 also slides in the first direction, such that the display panel 410, the interface board 450, and the FFC cable 460 slide together.

When the display panel 410, the interface board 450, and the FFC cable 460 slide together in the first direction, the plurality of second LM blocks LM2 and the plurality of third LM blocks LM3 slide together or sequentially in the state in which the printed circuit board 420 and the cover plate 550 are coupled.

That is, the plurality of second LM blocks LM2 is slid downward along the plurality of second guide rails R2 by the sliding movement of the display panel assembly 400 made by the rectilinear movement of the carrier 350.

When the plurality of second LM blocks LM2 slides in the first direction, the second support plate 520 is slid downward by the sliding movements of the plurality of second LM blocks LM2 while covering one side of the FFC cable 460.

When the plurality of second LM blocks LM2 is disposed at a lower end of the plurality of second guide rails R2, the plurality of third LM blocks LM3 slides downward along the plurality of third guide rails R3.

When the plurality of third LM blocks LM3 slides in the first direction, the third support plate 530 is slid downward by the sliding movements of the plurality of third LM blocks LM3 while covering one side of the FFC cable 460.

That is, in the state in which the printed circuit board 420 and the cover plate 550 are coupled, the display panel assembly 400 may be stably transferred because the sliding movement is supported by the three-stage structure made by the first LM block LM1, the second LM block LM2, and the third LM block LM3 that operate in conjunction with the rectilinear movement of the carrier 350.

When the always-on display area 411 and the expanded display area 412 are moved downward by the sliding movement of the third support plate 530 in the state in which the plurality of third LM blocks LM3 is disposed at a lower end of the plurality of third guide rails R3, the carrier 350 may come into contact with one side support block 320 or be disposed at a position adjacent to one side support block 320.

The position sensor S of the pair of position sensors S, which is disposed at the position corresponding to one side support block 320, may detect the position of the first LM block LM1 in accordance with the arrangement of the carrier 350 and transmits the position signal related to the first LM block LM1, which is detected to stop the movement of the carrier 350, to the power generation part.

When the power generation part detects that the sliding movement of the display panel assembly 400 in the first direction is completed in response to the received position signal related to the first LM block LM1, the power generation part may control (turn off) the operation of the drive motor 340, such that the sliding movement of the display panel assembly 400 may be completed.

In the state in which the expanded display area 412 is extended through the opening P-2 and moved downward during the sliding movement process of the display panel assembly 400, the expanded display area 412 may display images together with the always-on display area 411.

Hereinafter, a process in which only the always-on display area 411 is disposed below the roof panel P of the vehicle through the opening P-2 as the display panel assembly 400 slides in the second direction will be described.

When electric power is supplied again from the power generation part, the drive motor 340 transmits driving power to rotate the rotary shaft 330 in the reverse direction.

When the rotary shaft 330, which is connected to the rotary shaft of the drive motor 340 through the coupler 341, rotates, the carrier 350 is moved in the second direction. In this situation, the carrier 350 is moved while being supported by the first LM blocks LM1.

When the carrier 350 rectilinearly moves in the second direction, the second transfer bridge B2 integrally connected to the first transfer bridge B1 coupled to the carrier 350 also slides in the second direction, such that the display panel 410 slides in the second direction. At the same time, the connection plate 370 mounted on the connection bridge 380 coupled to the carrier 350 also slides in the second direction, such that the display panel 410, the interface board 450, and the FFC cable 460 slide together.

The display panel 410 slides upward in a state of being obliquely inclined along the second path and then curved and bent along the curved surface made by the arrangement of the plurality of lower rollers 220, and then the display panel 410 continuously moves in the second direction. The display panel 410 may be supported by the plurality of lower rollers 220, the plurality of support rollers 560, and the plurality of upper rollers 210 in the third path configured to connect the first path and the second path and define the curved surface.

When the display panel 410, the interface board 450, and the FFC cable 460 slide together in the second direction, the plurality of second LM blocks LM2 and the plurality of third LM blocks LM3 slide together or sequentially in the state in which the printed circuit board 420 and the cover plate 550 are coupled.

That is, the plurality of third LM blocks LM3 is slid upward along the plurality of third guide rails R3 by the sliding movement of the display panel assembly 400 made by the rectilinear movement of the carrier 350 in the second direction.

When the plurality of third LM blocks LM3 slides in the second direction, the third support plate 530 is slid upward by the sliding movements of the plurality of third LM blocks LM3 while covering one side of the FFC cable 460.

When the plurality of third LM blocks LM3 is disposed at an upper end of the plurality of third guide rails R3, the plurality of second LM blocks LM2 slides upward along the plurality of second guide rails R3.

When the plurality of second LM blocks LM2 slides in the second direction, the second support plate 520 is slid upward by the sliding movements of the plurality of second LM blocks LM2 while covering one side of the FFC cable 460.

When the plurality of second LM blocks LM2 is disposed above the plurality of second guide rails R2, the plurality of second guide rails R2, the plurality of second LM blocks LM2, the second support plate 520, the plurality of third guide rails R3, the plurality of third LM blocks LM3, the third support plate 530, the connection bar 540, and the cover plate 550 may be disposed on the other side surface (e.g., lower side surface) of the first support plate 510 while overlapping one another again.

When only the always-on display area 411 is disposed below the roof panel P of vehicle by the sliding movement of the second support plate 520 in the state in which the plurality of second LM blocks LM2 is disposed at the upper end of the plurality of second guide rails R2, the carrier 350 may come into contact with the other side support block 320 or be disposed at a position adjacent to the other side support block 320.

The position sensor S of the pair of position sensors S, which is disposed at the position corresponding to the other side support block 320, may detect the position of the first LM block LM1 in accordance with the arrangement of the carrier 350 and transmits the position signal related to the first LM block LM1, which is detected to stop the movement of the carrier 350, to the power generation part.

When the power generation part detects that the sliding movement of the display panel assembly 400 in the second direction is completed in response to the received position signal related to the first LM block LM1, the power generation part may control (turn off) the operation of the drive motor 340, such that the sliding movement of the display panel assembly 400 may be completed.

In the state in which the expanded display area 412 is moved upward through the opening P-2 during the sliding movement process of the display panel assembly 400, the expanded display area 412 may be accommodated in the mounting frame 100.

The various embodiments of the present disclosure can also be described as follows:

According to an aspect of the present disclosure, a slidable display device includes a mounting frame, and a display panel assembly slidably disposed inside the mounting frame and includes a display panel disposed to be movable to a lower side of the mounting frame, the display panel comprises an always-on display area kept in a state of being disposed below the mounting frame, and an expanded display area configured to slide from the inside of the mounting frame and display images in a state in which the expanded display area is disposed below the mounting frame.

The slidable display device may further comprise a guide member disposed at one end of the mounting frame and configured to guide the sliding movement of the display panel assembly.

The guide member may comprise a plurality of upper rollers and a plurality of lower rollers disposed to face one another, and the display panel assembly may slide in a state of being disposed between the plurality of upper rollers and the plurality of lower rollers.

The slidable display device may further comprise a panel transfer part disposed on the mounting frame and configured to slide the display panel assembly.

The panel transfer part may comprise a coupling plate fixed to the mounting frame, a pair of support blocks disposed on a lower surface of the coupling plate and spaced apart from each other, the pair of support blocks being connected through a rotary shaft and configured to support a rotation of the rotary shaft, a drive motor connected to the other side support block of the pair of support blocks and configured to transmit driving power to the rotary shaft, and a carrier disposed on the rotary shaft and configured to be moved by the drive motor.

The panel transfer part may further comprise a pair of supports disposed at two opposite sides of the pair of support blocks, a pair of first guide rails respectively coupled to lower surfaces of the pair of supports, a pair of first linear motion (LM) blocks movably disposed on the pair of first guide rails, respectively, a first transfer bridge coupled to a lower surface of the carrier and lower surfaces of the pair of first LM blocks and connected to the display panel assembly, and a connection plate coupled to a connection bridge disposed on the carrier, the connection plate being connected to the display panel assembly.

The display panel assembly may further comprise a printed circuit board electrically connected to an end of the display panel, a mid-cover disposed on one surface of the display panel and includes a plurality of opening portions, and a plurality of back bars disposed on one surface of the mid-cover.

The display panel assembly may further comprise an interface board mounted on the connection plate, a FFC cable configured to connect the interface board and the printed circuit board, a second transfer bridge disposed at an end of the mid-cover and connected to the first transfer bridge, and a dummy panel connected to the display panel and disposed at an upper end of the display panel opposite to a lower end of the display panel at which the printed circuit board is disposed.

The slidable display device may further comprise a movement support part coupled to the coupling plate and connected to the display panel assembly, the movement support part being configured to support the display panel assembly at one side thereof while covering the display panel assembly and configured to be expanded downward by the sliding movement of the display panel assembly.

The movement support part may comprise a first support plate coupled to the coupling plate, a plurality of second guide rails disposed on the other side surface of the first support plate, a plurality of second LM blocks respectively disposed on the plurality of second guide rails, a second support plate coupled to the other side surfaces of the plurality of second LM blocks and configured to slide, a plurality of third guide rails disposed on the other side surface of the second support plate, and a plurality of third LM blocks respectively disposed on the plurality of third guide rails.

The movement support part may further comprise a third support plate coupled to the other side surfaces of the plurality of third LM blocks and configured to slide, one or more connection bars disposed on the third support plate, and a cover plate coupled to the one or more connection bars and configured to cover the printed circuit board.

According to another aspect of the present disclosure, a slidable display device includes a housing having a panel transfer path, a display panel capable of being transferred along the panel transfer path, a transfer assembly configured to transfer the display panel, and a guide roller assembly disposed on the panel transfer path and configured to guide the transfer of the display panel, the panel transfer path comprises a first path extending in a first direction, a second path extending in a second direction inclined with respect to the first direction, and a third path configured to connect the first path and the second path and configured to allow the display panel to be transferred between the first path and the second path while having a curvature.

During the process in which the display panel is transferred, at least a part of the display panel may be transferred in the first direction, and another part of the display panel may be transferred in the second direction different from the first direction.

The transfer assembly may comprise a coupling plate fixed inside the housing, a pair of support blocks disposed on a lower surface of the coupling plate and spaced apart from each other, the pair of support blocks being connected through a rotary shaft and configured to support a rotation of the rotary shaft, a drive motor connected to the pair of support blocks and transmit driving power to the rotary shaft, a carrier disposed on the rotary shaft and configured to be moved by the drive motor, and a connection plate coupled to a connection bridge disposed on the carrier, the connection plate being connected to the display panel.

The display panel may comprise an interface board mounted on the connection plate, and a FFC cable configured to connect the interface board and a printed circuit board.

The interface board may slide to the first path when the carrier is moved in the first direction by driving power transmitted by the drive motor.

The FFC cable may be moved to the first path by the movement of the interface board, passes through a movement guide groove formed at one end of the coupling plate, and then moves along the second path.

The FFC cable may move in a curved and bent shape while passing through the movement guide groove.

The guide roller assembly may comprise a plurality of upper rollers and a plurality of lower rollers disposed inside the housing and disposed to face one another in a direction orthogonal to the first path, the guide roller assembly further comprises a plurality of support rollers disposed on an inner surface of one side of the housing, and the display panel may slide in the first path in a state of being disposed between the plurality of upper rollers and the plurality of lower rollers, and the display panel may slide in the third path in a state of being disposed between the plurality of support rollers and the plurality of lower rollers.

Although the various embodiments of the present disclosure have been described in detail with reference to the accompanying drawings, the present disclosure is not limited thereto and may be embodied in many different forms without departing from the technical concept of the present disclosure. Therefore, the various embodiments of the present disclosure are provided for illustrative purposes only but not intended to limit the technical concept of the present disclosure. The scope of the technical concept of the present disclosure is not limited thereto. Therefore, it should be understood that the above-described various embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A slidable display device comprising:
a display panel assembly including a display panel having a first display area and a second display area extending from the first display area; and
a mounting frame,
wherein the display panel assembly is movable in the mounting frame between a first position and a second position, the first position corresponding to a position in which the first display area extends beyond the mounting frame at a predetermined angle with respect to a portion of the second display area, and the second position corresponding to a position in which the first display area and the second display area extend at the predetermined angle beyond the mounting frame.

2. The slidable display device of claim 1, further comprising a panel transfer part connected to the display panel assembly, the panel transfer part being configured to move the display panel assembly between the first position and the second position.

3. The slidable display device of claim 2, wherein the panel transfer part is configured to convert rotary motion to linear motion to move the display panel assembly between the first position and the second position.

4. The slidable display device of claim 2, wherein the panel transfer part includes:
a drive motor;
a rotary shaft connected to the drive motor; and
a carrier configured to reciprocate between a first end of the rotary shaft and a second end of the rotary shaft, the carrier being connected to the display panel assembly.

5. The slidable display device of claim 4, wherein the panel transfer part further includes:
a coupling plate coupled to the mounting frame; and
a pair of stop blocks coupled to the coupling plate, the pair of stop blocks spaced apart at the first end and the second of the rotary shaft, respectively, the pair of stop blocks being configured to rotatably support the rotary shaft and limit a movement of the carrier along the rotary shaft.

6. The slidable display device of claim 5, wherein the panel transfer part further includes:
a pair of supports coupled to a lower surface of the coupling plate, the pair of supports extending parallel to the rotary shaft;
a pair of first linear motion guides coupled to the pair of supports, each first linear motion guide having:
a first guide rail; and
a linear motion block movably supported on the first guide rail; and
a first transfer bridge connecting the linear motion blocks of the pair of first linear motion guides to the carrier, the first transfer bridge being connected to the display panel assembly.

7. The slidable display device of claim of claim 6, wherein the panel transfer part includes a connection plate coupled to an upper surface of the carrier, and
wherein the display panel assembly further includes:
an interface board coupled to an upper surface of the connection plate;
a printed circuit board connected to the display panel; and
a flexible cable connecting the interface board and the printed circuit board.

8. The slidable display device of claim 7, wherein the display panel assembly further includes a second transfer bridge connected to the first transfer bridge.

9. The slidable display device of claim 8, wherein the display panel assembly further includes a dummy panel connected to the display panel, the dummy panel being disposed at an upper end of the display panel opposite to a lower end of the display panel at which the printed circuit board is disposed.

10. The slidable display device of claim 1, further comprising a guide member mounted at one end of the mounting frame, the guide member being configured to guide a movement of the display panel assembly between the first position and the second position.

11. The slidable display device of claim 10, wherein the mounting frame defines a transfer path along which the display panel assembly moves between the first position and the second position, the transfer path including:
a first path extending in a first direction;
a second path extending in a second direction at the predetermined angle relative to the first direction; and
a connection path between the first path and the second path, and
wherein the guide member is located along the connection path.

12. The slidable display device of claim 10, wherein the guide member includes:
at least one upper roller at an upper surface of the display panel assembly; and
at least one lower roller at a lower surface of the display panel assembly.

13. The slidable display device of claim 12, wherein the at least one upper roller includes a plurality of upper rollers,
wherein the at least one lower roller includes a plurality of lower rollers, and
wherein a number of the lower rollers is greater than a number of the upper rollers.

14. The slidable display device of claim 1, further comprising a movement support part at one end of the mounting frame, the movement support part being configured to support the display panel assembly as the display panel assembly moves between the first position and the second position.

15. The slidable display device of claim 14, wherein the movement support part is configured to extend as the display panel assembly moves from the first position to the second position.

16. The slidable display device of claim 15, wherein the movement support part includes:
a first support plate coupled to the one end of the mounting frame;
a second support plate slidably coupled to the first support plate; and
a third support plate slidably coupled to the second support plate, the third support plate being connected to an end of the display panel assembly extending from the mounting frame.

17. The slidable display device of claim 16, wherein the movement support part includes:
a plurality of second linear motion guides coupling the first support plate to the second support plate; and
a plurality of third linear motion guides coupling the second support plate to the third support plate.

18. The slidable display device of claim 16, wherein the display panel assembly further includes a printed circuit board electrically connected to an end of the display panel, and
wherein the third support plate covers the printed circuit board.

19. The slidable display device of claim 18, wherein the display panel assembly further includes:
a printed circuit board electrically connected to an end of the display panel;
a mid-cover disposed on one surface of the display panel; and
a plurality of back bars disposed on one surface of the mid-cover, and
wherein the mid-cover and the plurality of back bars are located between the display panel and the movement support part.

20. A slidable display device comprising:
a housing having a panel transfer path;
a display panel being configured to move along the panel transfer path;
a transfer assembly configured to move the display panel along the panel transfer path; and
a guide roller assembly disposed on the panel transfer path, the guide roller assembly being configured to guide the display panel as the display moves along the panel transfer path,
wherein the panel transfer path comprises:
a first path extending in a first direction;
a second path extending in a second direction inclined with respect to the first direction; and
a third path connecting the first path and the second path, the third path being configured to bend the display panel while being moved between the first path and the second path.

21. The slidable display device of claim 20, wherein, during movement of the display panel along the panel transfer path, at least a part of the display panel is moved in the first direction and another part of the display panel is moved in the second direction different from the first direction.

22. The slidable display device of claim 20, wherein the transfer assembly comprises:
a coupling plate fixed inside the housing;
a pair of support blocks disposed on a lower surface of the coupling plate, the pair of support blocks being spaced apart from each other;
a rotary shaft rotatably supported by the pair of support blocks;
a drive motor configured to transmit driving power to the rotary shaft;
a carrier disposed on the rotary shaft, the carrier being configured to be moved by rotation of the rotary shaft;
a connection bridge disposed on the carrier; and
a connection plate coupled to the connection bridge and the display panel.

23. The slidable display device of claim 22, further comprising:
a printed circuit board connected to the display panel;
an interface board mounted on the connection plate; and
a flexible cable connecting the interface board and the printed circuit board.

24. The slidable display device of claim 23, wherein the interface board is configured to slide along the first path when the carrier is moved in the first direction by driving power transmitted by the drive motor.

25. The slidable display device of claim 24, wherein the flexible cable is configured to move along the first path in response to movement of the interface board.

26. The slidable display device of claim 25, wherein the coupling plate includes a movement guide groove, and
wherein the flexible cable is configured to bend while passing through the movement guide groove as the flexible cable moves along the panel transfer path.

27. The slidable display device of claim 20, wherein the guide roller assembly comprises:
at least one upper roller disposed inside the housing;
a plurality of lower rollers disposed inside the housing; and
at least one support roller disposed inside the housing,
wherein, as the display panel moves along the panel transfer path, a first portion of the display panel moves between the at least one upper roller and at least a first lower roller of the plurality of lower rollers in the first path and a second portion of the display panel moves between the at least one support roller and a second lower roller of the plurality of lower rollers in the third path.

28. A roof panel assembly for a vehicle, the roof panel assembly comprising:
a roof panel having an opening: and
a slidable display device connected to the roof panel assembly, the slidable display device including:
a display panel assembly including a display panel having a first display area and a second display area extending from the first display area; and
a mounting frame,
wherein the display panel assembly is movable in the mounting frame between a first position and a second position, the first position corresponding to a position in which the first display area extends through the opening of the roof panel at a predetermined angle with respect to a portion of the second display area, and the second position corresponding to a position in which the first display area and the second display area extend through the opening of the roof panel at the predetermined angle beyond the mounting frame.

29. The roof panel assembly of claim 28, further comprising:
a panel transfer part connected to the display panel assembly, the panel transfer part being configured to move the display panel assembly between the first position and the second position; and
a movement support part at one end of the mounting frame, the movement support part being configured to support the display panel assembly as the display panel assembly moves between the first position and the second position.

30. The slidable display device of claim 29, further comprising a guide member mounted at one end of the mounting frame, the guide member being configured to guide a movement of the display panel assembly between the first position and the second position.

31. The slidable display device of claim 30, wherein the mounting frame defines a transfer path along which the display panel assembly moves between the first position and the second position, the transfer path including:
a first path extending in a first direction;
a second path extending in a second direction at the predetermined angle relative to the first direction; and
a connection path between the first path and the second path, and
wherein the guide member is located along the connection path.

32. The slidable display device of claim 31, wherein the movement support part is configured to be extended parallel to the second path.
